(19) United States
(12) Patent Application Publication
(10) Pub. No.: US 2025/0356120 A1
(43) Pub. Date: Nov. 20, 2025

(54) DYNAMIC PARALLEL NESTED LLM PROMPTS WITH STREAMING ACTIONS

(71) Applicant: SoundHound AI IP, LLC, Santa Clara, CA (US)

(72) Inventors: Keyvan Mohajer, Atherton, CA (US); Johannes Huwald, Hamburg (DE); Philipp Hubert, Toronto (CA); Timothy P. Stonehocker, Sunnyvale, CA (US)

(73) Assignee: SoundHound AI IP, LLC, Santa Clara, CA (US)

(21) Appl. No.: 18/666,627

(22) Filed: May 16, 2024

(51) Int. Cl. G06F 40/284; G06F 40/40

(52) U.S. Cl. CPC G06F 40/284; G06F 40/40

(57) ABSTRACT

A system and method processes token groups input to an LLM in parallel and/or by nested processing. Each token group may consist of one or more tokens from a system prompt and user prompt. In addition to simple parallel processing of the one or more token groups, prompts may be input as nested prompts, where processing of one or more token groups may be begin and end at different times, depending on satisfaction of a start and/or end condition.

### FIELD

The present technology relates to interaction with a large language model, and in particular to a system and method enabling parallel, nested and dynamic processing of prompt entries to a large language model.

### BACKGROUND

Lage language models (LLMs) have great potential to advance human interaction with voice and digital assistants. These models employ artificial intelligence to understand language and generate natural, human-like responses to queries to provide rich conversational interactions. One problem with LLMs is that the dataset they use is so large that it may take long periods of time to process and respond to queries. A query is received into an LLM in the form of a spoken or written prompt, which is broken down into individual tokens for analysis. A token refers to a basic unit of text that the model processes, typically individual words or punctuation marks.

Users can interact with LLMs directly, or through service provider platforms such as voice recognition platforms. When interacting with an LLM through a service provider platform, the platform may provide system prompts to an LLM in addition to the user's input prompt. System prompts are additional text provided by the service provider platform to guide, shape and/or better understand the LLM response to the user's input prompt. These system prompts are usually not visible to the user but are provided together with a user input prompt by the service provider platform to an LLM. Analysis and processing of system prompts along with user input prompts further slows the processing time for the LLM response.

### DESCRIPTION OF THE DRAWINGS

FIG. 1 is a schematic representation of a dynamic, parallel, nested and streaming prompt system according to embodiments of the present technology.

FIG. 2 is an illustration of a prompt comprising system prompt and user prompt components according to embodiments of the present technology.

FIG. 3 is a flowchart showing operation of parallel processing of prompts according to embodiments of the present technology.

FIG. 4 is a generic illustration of a prompt broken into token groups according to embodiments of the present technology.

FIG. 5 is an illustrative example of a prompt broken into token groups according to embodiments of the present technology.

FIG. 6 is a generic illustration of a prompt broken into token groups according to further embodiments of the present technology.

FIG. 7 is an illustrative example of a prompt broken into token groups according to further embodiments of the present technology.

FIG. 8 is a generic illustration of a prompt broken into token groups according to further embodiments of the present technology.

FIGS. 9 and 10 together comprise a flowchart showing the operation of nested loop processing of prompts according to embodiments of the present technology.

FIG. 11 is a schematic block diagram of a computing environment according to embodiments of the present technology.

### DETAILED DESCRIPTION

The present technology will now be described with reference to the figures, which in general relate to a system and method for processing token groups input to an LLM in parallel and/or by nested processing. Each token group may consist of one or more tokens from a system prompt and user prompt. In addition to simple parallel processing of the one or more token groups, prompts may be input as nested prompts, where processing of one or more token groups may be begin and end at different times, depending on satisfaction of a start and/or end condition. One or more of the token groups may have dynamic values which change based on the state of earlier searched token groups. Analysis of the one or more token groups may proceed deterministically, start to finish, to obtain the final results. Alternatively, using nested searches and dynamic prompts, analysis of token groups may be recursive, with a single token group be analyzed two or more times with different state values.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

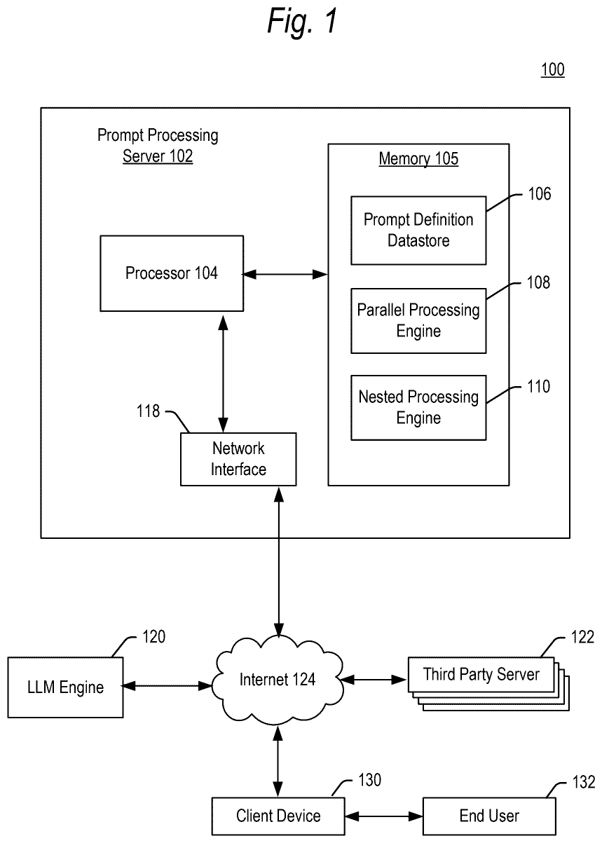

FIG. 1 is a schematic block diagram of a sample prompt processing architecture 100 including a prompt processing server 102 which may be resident on a service provider platform. The service provider platform may for example be a platform providing voice recognition and verbal interaction services with an LLM, but other types of service providers are contemplated. The server 102 may be physically located at a single service provider facility, or it may comprise one or more servers distributed over multiple locations.

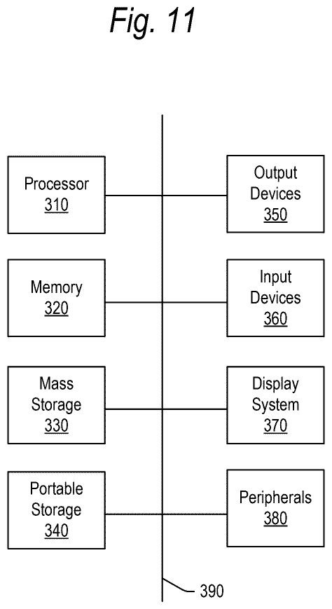

A more detailed explanation of a sample server 102 is described below with reference to FIG. 11, but in general, server 102 may include a processor 104 configured to control the operations of server 102, as well as facilitate communications between various components within server 102. The processor 104 may include a standardized processor, a specialized processor, a microprocessor, or the like that may execute instructions for controlling server 102. As explained below, processor 104 may include, or be in communication with, a large language model engine (LLM engine) 120 for responding to user queries input through the server 102.

The server 102 may further include a memory 105 that may store algorithms that may be executed by the processor 104. According to an example embodiment, the memory 105 may include RAM, ROM, cache, flash memory, a hard disk, and/or any other suitable storage component. As shown in FIG. 1, in one embodiment, the memory 105 may be a separate component in communication with the processor 104, but the memory 105 may be integrated into the processor 104 in further embodiments.

Memory 105 may store various data stores and/or software application programs executed by the processor 104 for controlling the operation of the server 102. One such datastore from implementing aspects of the present technology includes a prompt definition datastore 106. Examples of the application programs for implementing aspects of the present technology include the parallel processing engine 108 and a nested processing engine 110. Each of these datastores and application programs are explained in greater detail below.

The prompt processing server 102 may further include communications circuitry such as a network interface 118 for connecting to the Internet 124. The server 102 may include additional components for example as described below with respect to FIG. 11.

Embodiments of the present technology use generative artificial intelligence (GAI), for example a large language model, as a virtual assistant handling user queries. In embodiments, the processor 104 may be in communication with an LLM engine 120 via the Internet 124. In further embodiments, the LLM engine 120 may be integrated into the processor 104 of prompt processing server 102. LLM engine 120 receives an input, or prompt, and uses models and algorithms to generate an output including new, original content based on a given dataset on which engine 120 is trained. LLM engine 120 may be an existing generative neural network, such as ChatGPT-3, ChatGPT-4, or other known models. These models have been trained on extensive datasets and possess the ability to generate coherent and contextually relevant text based on provided input. In one example, the LLM engine 120 may be trained and developed by the following steps.

Data Collection and Preprocessing: The LLM engine 120 may be provided with a diverse and extensive data set including a wide range of text from various sources, such as books, articles, websites, and more. The data may be preprocessed to ensure consistency, remove noise, and normalize the input format. The text may be broken down into smaller units, often words or subwords. Each unit may be assigned a unique identifier or token.

Model Architecture Selection: The LLM engine 120 may be configured in different model architectures, including for example a transformer architecture, generative adversarial network (GAN), a variational autoencoder (VAE), an autoregressive model, or other types of models designed for generative tasks. For large language models like GPT, the architecture is often based on the transformer architecture, which utilizes self-attention mechanisms. Self-attention mechanisms enable the model to weigh the importance of different words in a sequence when processing each word, allowing the model to capture relationships and dependencies between words more effectively.

Training the Model: The LLM engine 120 may then be trained using the prepared dataset. During training, the dataset may be divided into training, validation, and test sets. The training set is used to update the model parameters, the validation set is used to fine-tune hyperparameters and prevent overfitting, and the test set evaluates the model's generalization to unseen data. Using an optimization algorithm (e.g., stochastic gradient descent) the model parameters are iteratively updated based on the training data. The model is regularly evaluated based on the validation dataset to monitor its performance. The test set is used to assess the final performance and generalization of the model.

It is understood that the above steps for developing and training LLM engine 120 are by way of a summary example only, and other or alternative steps may be used to develop and/or train a LLM engine 120 for use with the present technology.

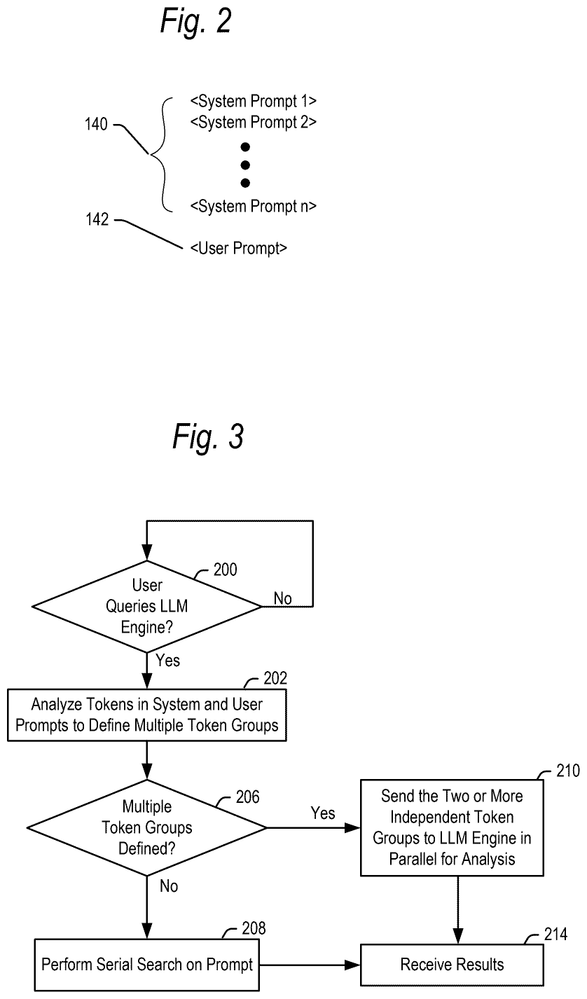

As mentioned above, prompts coming from a service provider such as from server 102 may include system prompts which get sent to the LLM engine 120 together with any user prompt. FIG. 2 is an illustration of a prompt which may get sent to the LLM engine 120 from server 102. The prompt may have one or more system prompts (System Prompt 1, System Prompt 2, . . . , System Prompt n) 140 and a user prompt 142. As indicated, the one or more system prompts 140 may be invisible to the user, and may get automatically sent by the server 102 along with the user prompt 142.

FIG. 3 is a flowchart showing the operation of a simple embodiment for parallel processing of prompts input by server 102 to the LLM engine 120. Further embodiments relate to nested and dynamic prompts with the possibility of recursive loops. Those embodiments will be explained below. Parallel processing of prompts may be performed by the parallel processing engine 108 of server 102 in combination with processor 104. In step 200, the engine 108 looks for a user prompt for the LLM engine 120. Upon receipt of such a prompt, the engine 108 analyzes the tokens in the system and user prompts to define multiple token groups in step 202. The criteria that the engine 108 uses in step 202 is whether one or more of the tokens received in step 200 may be searched independently of each other. For example, typically system prompts are unrelated to each other and may be searched independently. As for the user prompt, where 2 or more tokens are unrelated (for example do not modify each other), they may be searched independently. Engine 108 by itself may perform step 202 by itself. Alternatively, the query including system and user prompts may be sent to the LLM engine 120 for initial analysis, with the engine 120 determining which tokens may be searched independently of each other.

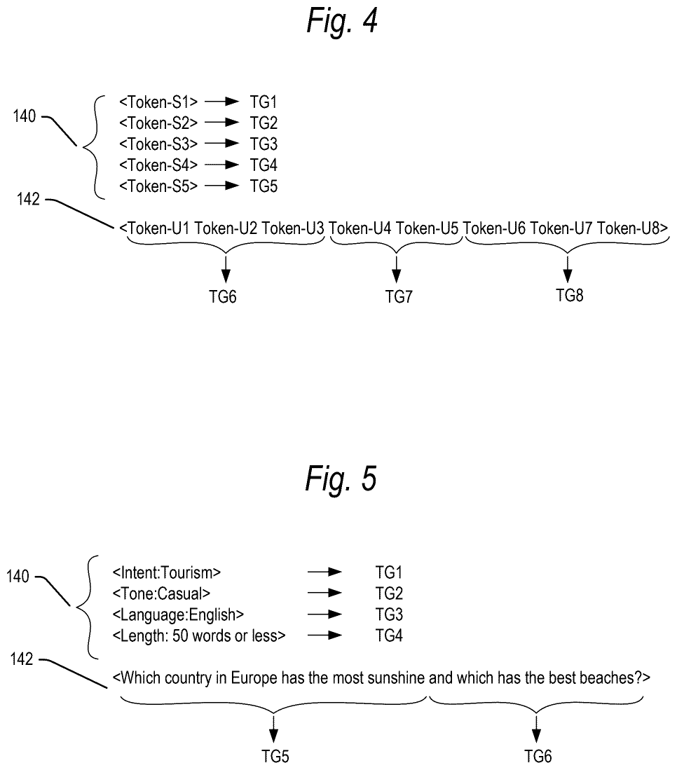

Upon identifying the tokens in the system and/or user prompts which may be searched independently, independent tokens are classified and stored into their own token groups. FIG. 4 illustrates an example of a prompt including system tokens S1-S5 and user tokens U1-U6 from the user query. In step 202, the parallel prompt engine 108 (alone or with assistance from LLM engine 120) has classified the various tokens into 8 token groups TG1-TG8. In particular, each system prompt was broken into its own token group, and it was determined that user tokens U1-U3 comprise a token group, tokens U4-U5 comprise a token group and tokens U6-U8 comprise a token group. It is understood that the number and breakdown of tokens and token groups shown in FIG. 4 is by way of example only for illustrative purposes, and that any number of tokens may be broken down into any number of token groups in further embodiments. For example, the user prompt may include many more tokens, possibly broken down into additional token groups.

FIG. 5 illustrates an actual example where a user has presented a query:
“Which country in Europe has the most sunshine and which has the best beaches?”
   In this example, the service provider server 102 may additionally include system prompts of <Intent:Tourism>, <Tone:Casual>, <Language:English> and <Length:50 words or less>. The parallel processing engine 108 may parse this query including the system prompts 140 and user prompt 142 into six different token groups. The parallel processing engine 108 (by itself or in combination with LLM engine 120) may determine that each system prompt 140 may be its own token group TG1-TG4. The parallel processing engine 108 (by itself or in combination with LLM engine 120) may determine that the user prompts can be broken down into two token groups TG5 and TG6. Each of these token groups TG1-TG6 may be searched in parallel by the parallel processing engine 108.

The example of FIG. 5 illustrates a further concept of the present technology. In particular, one or more tokens from one token group may be imported into another token group for context. TG5 includes the tokens “which country in Europe has . . . ” TG6 includes the tokens “and which has . . . ” If searched by itself, TG6 would not capture the user intent of finding the best beaches specifically in Europe. Thus, the parallel processing engine (by itself or in combination with LLM engine 120) may import “country in Europe” from TG5 into TG6 so that the token group TG6 presented to the LLM engine 120 is “and which country in Europe has the best beaches?>. Likewise, the question mark from the token group TG6 may be imported into TG5.

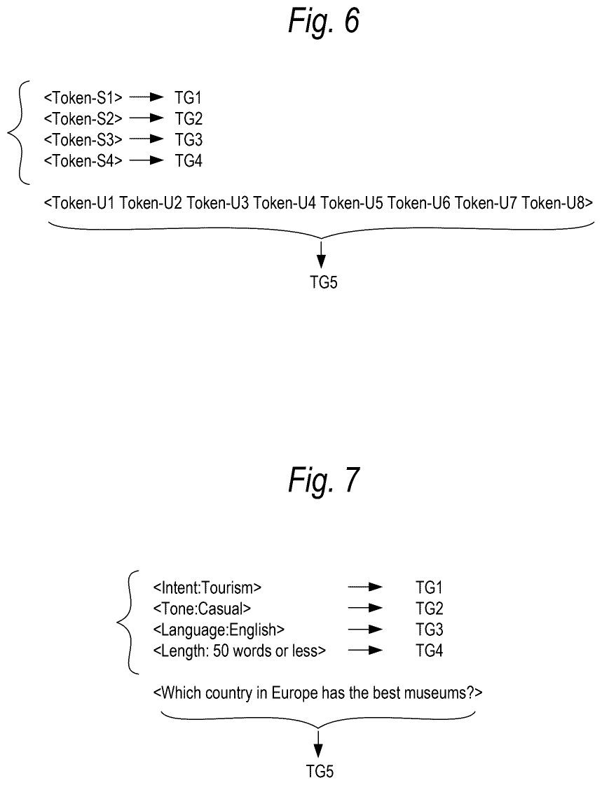

In the embodiment above, the user input query was parsed into separate token groups. However, it may happen that the user query is not easily separated into independent token groups. Thus, in further embodiments illustrated for example in FIG. 6, the tokens of the user query may not be separated, but rather taken as a whole as a single token group. Each of the system tokens may still be treated as separate token groups so that the single user input token group can be searched in parallel with one or more of the separate system token groups.

FIG. 7 illustrates an actual example where a user has presented a query:
“Which country in Europe has the best museums?”
   In this example, the service provider server 102 may additionally include system prompts of <Intent:Tourism>, <Tone:Casual>, <Language:English> and <Length:50 words or less> as above. The parallel processing engine 108 may parse this query including the system prompts 140 and user prompt 142 into five different token groups. The parallel processing engine 108 (by itself or in combination with LLM engine 120) may determine that each system prompt 140 may be its own token group TG1-TG4. The parallel processing engine 108 (by itself or in combination with LLM engine 120) may determine that the user prompts cannot be contextually broken down into different token groups and is to be searched as a whole. However, the user token group TG5 may be searched in parallel with the token groups TG1-TG4 from the system prompts.

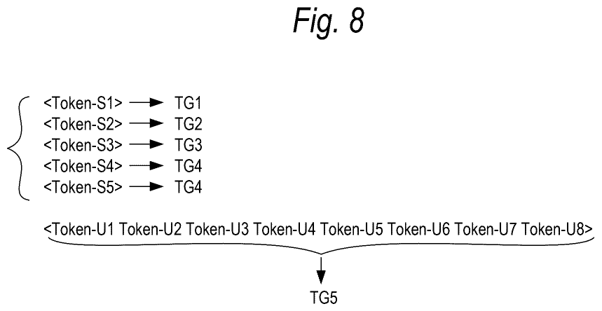

As a further example, it may happen that one or more of the system prompts are contextually dependent on another system prompt or the user prompt, and cannot be searched in parallel. This scenario is shown generically in FIG. 8, where the system prompts S4 and S5 are dependent on each other (and both are grouped together into token group TG4). For example, one known system prompt is to receive a confidence value <Response Confidence> on a given response <Response>. In this example, <Response Confidence> cannot be obtained until after <Response> is received. In this example, <Response> and <Response Confidence> may be grouped together in a single token group.

Returning now to the flowchart of FIG. 3, in step 206 the engine 108 checks whether multiple token groups have been defined. If not, a serial (conventional) search of the system and user prompts are performed in step 208 through LLM engine 120 and the results are received in step 214.

On the other hand, if it is determined in step 206 that multiple token groups have been defined (such as for example as shown in FIG. 4), then each token group is sent for analysis to the LLM engine 120 in parallel and the results are received in step 214. Using parallel processing of individual token groups, the parallel processing engine 108 is able to reduce the time it takes to analyze a query and return the results to a fraction of the time needed for a conventional serial search of a query. As the system determined that the individual token groups were independent of each other, searching of the token groups independently will not affect the result found by the LLM engine 120 as compared to a conventional serial search of the query.

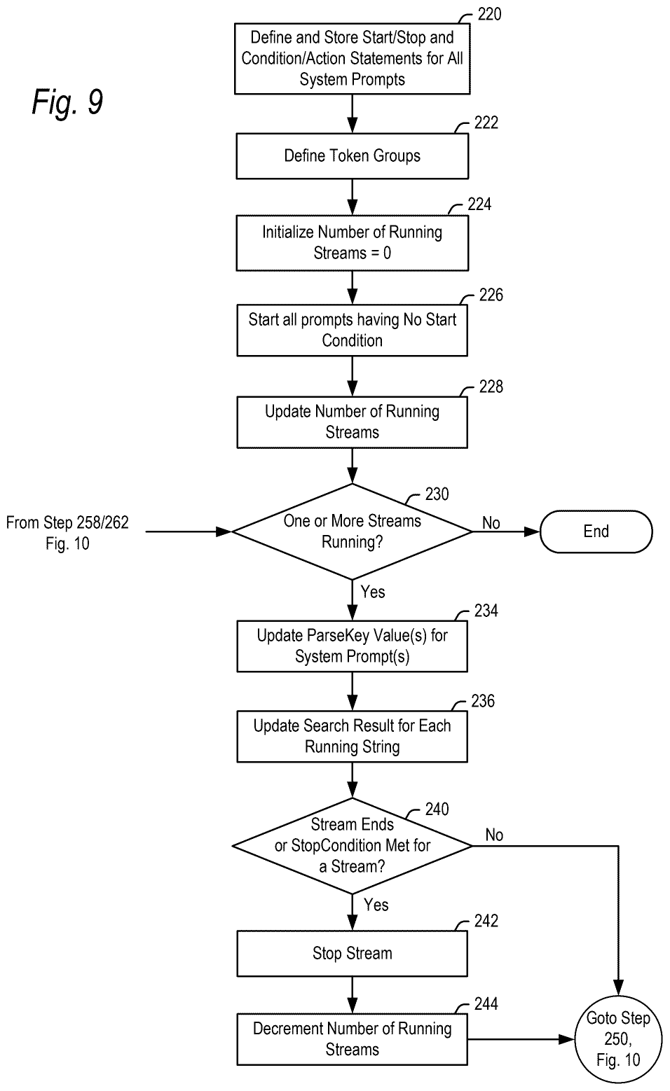

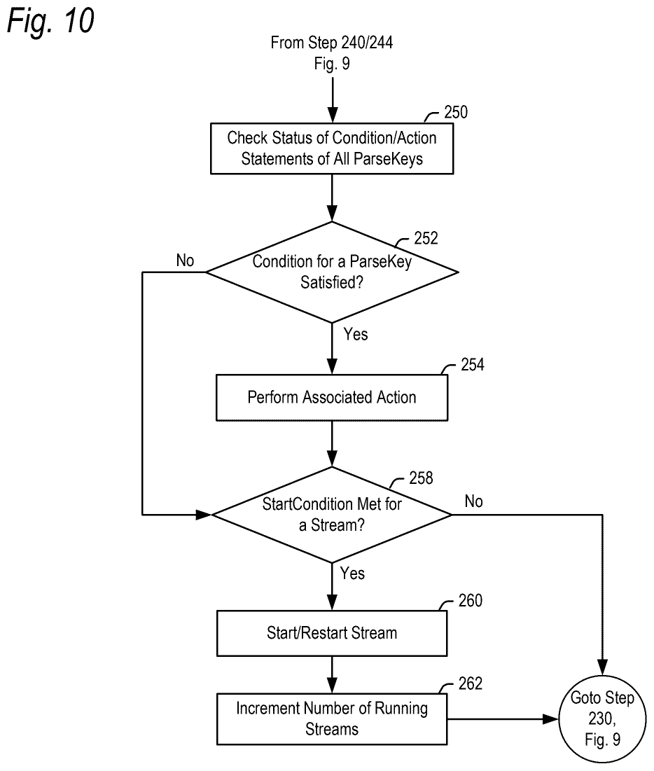

In the embodiment described above with respect to the flowchart of FIG. 3, token groups are processed in parallel at the same time from start to finish. Some LLMs may have a token limit, or it may otherwise be desirable to break a query into one or more token groups which are processed with different beginning and ending times, depending on satisfaction of a start and/or end condition. This type of operation is referred to herein as a nested query or prompt, which will now be described with reference to the flowchart of FIGS. 9 and 10. While parallel prompts can run independently of each other, nested prompts can run conditionally depending on the conditional values of earlier prompts.

In an example, a query might be defined by a large number of token groups, some of them system prompts and some of them user prompts. A first subset of one or more of these token groups might run in parallel at the start (i.e., no starting condition). Depending on the result from the LLM engine 120, a second subset of one or more of the token groups may then run. That is, a result from the first subset of prompts triggered a start condition for one or more prompts of the second subset, which then runs as a new (nested) query to LLM engine 120. Running the second subset of token groups may trigger a third nested search of a third subset of one or more token groups, and so on. These streams of two or more nested searches may continue until the query as a whole has completely run. Below are general steps from an algorithm run by nested processing engine 110 (FIG. 1) for controlling the operation of nested queries.

```
“DynamicPrompts”: [
{
  “StartCondition”: ...
  “StopCondition”: ...
  “Prompt”: {
      ...
      }
  “ParseKeys”: [“”,“”,...],
  “Actions”: [{
      “Condition”: “...”,
      “Action”: {}
    },...]
},
...
]
```

For each token group, the nested processing engine 110 continuously runs through the steps of the general algorithm above to start/end initial and nested searches through the LLM engine 120. Depending on results from LLM engine 120, all of the prompts may run, or only some of the prompts may run. For example, if a start condition of a subset of tokens is never satisfied, the query to LLM engine 120 may not be run on that subset of tokens. Additionally, one or more of the prompts may be run more than once as explained below.

“DynamicPrompts”: [ . . . ]—This is the subroutine which the nested prompt engine 110 runs through continuously until all subsets, or streams, of token groups have been processed and results have been returned. Some prompts (likely system prompts but not necessarily) may include key-value pairs. The key, referred to in the algorithm as a ParseKey, may have an associated tag. This tag may have a constant value. Alternatively, as explained below, the tag may have a variable or dynamic value which may get updated as the algorithm loops.

```
  {
“StartCondition”: ...
“StopCondition”: ...
“Prompt”: {
  ...
  }
```

These lines of the algorithm define a particular prompt, and any start and/or stop conditions associated with a particular prompt. The prompt may be a system prompt, a user defined prompt or a prompt consisting of a token group as discussed above with respect to the parallel processing engine 108.

The above lines of the algorithm also define a start and stop condition for a given prompt. Where no starting condition is defined, the prompt may automatically run as part of the first subset of prompts. Where a starting condition is defined, the prompt will run upon satisfaction of the starting condition and will not run if the starting condition is not satisfied. Normally, once a prompt begins to run, it will run to its completion. However, where a stop condition is defined, a prompt may stop running before its completion upon satisfaction of the stop condition.

```
“ParseKeys”: [“”,“”,...],
  “Actions”: [{
    “Condition”: “...”,
    “Action”: { }
},...]
```

This portion of the algorithm defines one or more condition/action statements for parsekeys within a prompt. The condition is defined, as well as the action to be taken upon satisfaction of the parsekey condition. As values get populated, these condition/action statements can trigger various actions, including triggering one or more additional prompts to be run.

FIGS. 9 and 10 comprise a single flowchart spread over two figures showing the operation of nested loop engine 110 to run nested prompts, using for example the above-identified algorithm as a framework. In step 220, the nested loop engine 110 may store any predefined start/stop conditions for system prompts and/or any Condition/Action statements for system prompts. These conditions and statements may be stored in the prompt definition datastore 106 (FIG. 1).

In step 222, the system prompts and user prompt may be divided into token groups, also referred to herein as streams. Step 222 may use any of the methods described above with respect to FIG. 3 for parsing the system and user prompts into token groups. Each of these token groups may be run independently as nested streams as explained below.

In step 224, a counter in memory for keeping track of the number of running streams is initialized to 0. In step 226, any of the streams defined in step 222 which have no start condition may run in parallel. These streams may be sent to LLM engine 120 for processing in parallel as explained above with respect to FIG. 3. In step 228, the counter for the number of running streams is updated.

In step 230, the nested loop engine 110 checks the counter to see if any streams are running. If not, this means that all processing of streams has been completed and the flow ends. On the other hand, assuming the counter shows one or more streams running in step 230, the values of any ParseKey prompts are updated in step 234. In particular, the tags associated with ParseKeys may be constant, or they may be dynamic (variable). As one easy example, a ParseKey may exist as <Confirming Query>. This ParseKey in effect causes the LLM engine 120 to present an introductory response merely confirming the user input query. So in response to one of the above example queries:
“which country in Europe has the best museums?”
   The LLM engine 120 may provide an initial confirmation based on the <Confirming Query> ParseKey:
“Certainly, here's a response to the query “which country in Europe has the best museums?”
   In this example, the tag or argument for the ParseKey <Confirming Query> is dynamic and will change depending on what the user input query is. There are a large number of other examples where the tag associated with a given ParseKey may be dynamic. In step 234 the current state of the tags for ParseKeys are checked and, if conditions have changed since the last check, the state is updated.

In step 236, the search results for all running streams are updated, using the current state of all ParseKeys. This update may comprise sending the streams then running to the LLM engine 120 for analysis, or this update may comprise sending only the updated streams (those having updated ParseKeys) to the LLM engine 120 for analysis.

In step 240, the nested loop engine 110 checks whether a stream has naturally run to its completion, or a defined stop condition has been met for one or more of the streams then running. If so, those one or more streams are stopped in step 242. In step 244, the counter is decremented by the number of streams which were stopped in step 242.

If no streams ended in step 240, or if streams ended and steps 242, 244 were performed, the nested loop engine 110 then proceeds to step 250 in FIG. 10. In step 250, the nested loop engine 110 checks the status of any Condition/Action statements from ParseKeys with active streams. As noted above, ParseKeys may define some action to be performed upon satisfaction of some condition. As one simple example, a ParseKey may trigger the start of a new stream upon satisfaction of the defined condition. As another example, a <Language> ParseKey may be defined which states that where an input query is received in a language other than English, the response from LLM engine 120 is provided in the received language. As a further action, if a condition is satisfied, a ParseKey may set an action to run an API accessing a third-party server 122 (FIG. 1) instead of or in addition to LLM engine 120. A wide variety of Condition/Action statements may be checked in step 252. In step 254, where a condition in a ParseKey for an action to be performed is satisfied, the action is performed in step 254. Where no conditions for running streams are satisfied in step 252, step 254 is skipped.

In step 258, the nested loop engine 110 checks whether a changed condition has triggered the start of a new stream. If so, the new stream is started in step 260, and the counter is incremented in step 262.

In a further aspect of the present technology, nested loops may be performed recursively. That is, a first stream may trigger a second stream and then end. The second stream may in turn trigger the first stream to restart. Thus, steps 258 and 260 do not just check for trigger events of streams that have not yet run. The nested loop engine 110 also checks streams that have already run. If the condition is satisfied for a loop to recursively run again, that loop is restarted in step 260 and the number of streams in incremented in step 262. If no start condition was triggered in step 258, or a new stream was started in steps 260 and 262, the flow returns to step 230 (FIG. 9) to run through the loop again.

As an example of the recursive feature of the present technology, a user prompt can generate Subtask1 which can either generate the final result or a Subtask2. If it generates the final result, the final result is sent to the user and the nested prompts end. If Subtask2 is generated, it can send an update to the user and dynamically modify the prompt to generate the next result, which can be the final result or a new Subtask3, and this can continue until either the final result is reached or a maximum number of iterations is reached.

It is understood that the above flowcharts for showing the operation of the parallel processing engine 108 (FIG. 3) and the nested loop engine 110 (FIGS. 9 and 10 and 11) are by way of example only. Certain steps may be performed in different orders or omitted entirely, and other steps are possible.

The following is an implementation example of the nested loop engine 110. In this example, using a client device 130 (FIG. 1) a user 132 inputs query to server 102, for example verbally:
“Tell me if it is going to rain in San Francisco at 9 pm and show me Italian restaurants there that are open then.”

Running through the steps of the flowchart of FIGS. 9-10, in a first step, the Dynamic Prompt algorithm shown above runs a first system prompt to classify the intent and it gets an array “<Intent: Weather, Restaurant Search>”. A <Confirming Query> ParseKey may also be used to generate a confirmation of the query.

For each intent, the nested loop engine 110 then runs a separate prompt in parallel (no start condition). For the weather stream, the engine 110 runs a weather-specific system prompt to generate the weather-specific key-value pairs:
<Location: San Francisco>
<Date: today>
<Time: 9 pm>
<Attribute: rain>

For the restaurant stream, the engine 110 runs another prompt in parallel to collect other key-value pairs:
<Location: San Francisco>
<Open: 9 pm>
<Cuisine: Italian>

Each prompt above will have an Action that gets triggered based on some conditions. The service provider of server 102 is aware that for current events, such as weather conditions, the LLM model does not have information. Server 102 may implement a further dynamic ParseKey checking on whether a query is asking for current events (or events taking place after the training of the LLM engine 120), such as for example, <RecentTopic>, with the binary tag of 1 for recent topic (after LLM engine training) or 0 for older topic (for which LLM was trained). Using the output of <RecentTopic>, the nested loop engine 110 may identify both streams as asking for current events for which the LLM engine 120 is not trained.

Therefore, for weather, if Location, Date, Time, Attribute are present, the Action to perform is to run an API which accesses a third-party server 122, which includes current event information such as current weather data. In embodiments, the third-party server 122 may instead be under the controller of the service provider implementing server 102. The third-party server 122 may then return a response to the weather query to the user.

Similarly, for restaurants, once the nested loop engine 110 has the requisite attributes to satisfy the predefined condition, the Action to perform is to run another API which accesses a third-party server 122, which includes current event information such as current restaurant data. The third-party server 122 may then return a response to the restaurant query to the user. Thus, in the final step, the engine 110, in cooperation with the LLM engine 120 and/or one or more third party servers 122, may return a response (for example audibly through the service provider of server 102):
“You asked if it is going to rain in San Francisco at 9 pm and to show Italian restaurants there that are open then. The chance of rain in San Francisco at 9 pm today is 80%. At 9 pm, there are several Italian restaurants that are open, including [restaurant names]”

In embodiments, the results from the various streams from any of the above-identified embodiments may be collected by the server 102 and presented to the user all at once, and actions on parse keys can be taken upon completion of processing on a given prompt. However, in accordance with further aspects of the present technologies, all results may be streamed in real time. As the results from one stream or another become available, the results may be streamed to the user, and actions can be taken on parse keys before completion of processing of a prompt as a whole.

For example, as described above, the nested loop engine 110 can start processing a second or subsequent stream upon satisfaction of a start condition in an earlier stream. Using the flow as described in FIGS. 9 and 10, key-value pairs can be parsed out of the response in real time, and if other nested prompts depend on some of these key values pairs, they can start generating and streaming their results as soon as their conditions are met. For example, if PromptA generates <Key1> and <Key2> in sequence, and PromptB needs to wait for <Key1> before it starts, then the nested loop engine 110 can start PromptB as soon as we have <Key1> and it does not need to wait for the entire response of PromptA to finish.

Stop conditions for streams are also discussed above. The nested loop engine 110 can stop the response generation of a certain prompt before it finishes on its own based on the key value pairs that are parsed from the current and other prompts. For example, if PromptA generates <Key1> and <Key2>, and PromptB generates <Key3> and <Key4>, and PromptB starts after <Key1> is available, but <Key2> and <Key4> are not necessary based on certain values of <Key1> and <Key3>, the nested loop engine 110 can stop both PromptA and PromptB before they finish generating if those conditions on <Key1> and <Key3> are met.

Results can also be streamed to client devices 130 as soon as the results are available. The service provider server 102 has the ability to send updated results to the client device 130. For complex tasks that can take tens of seconds, if the user 132 has to wait tens of seconds for the final response, the user experience is degraded. However, if real time progress updates are provided more frequently, e.g., every few seconds, the user experience for the response is improved. As an example:
User: complete TaskA
Response 1: Got it! Let me work on completing TaskA
Response 2: I found SubTastk1 and Subtask2. Checking on both.
Response 3: Subtask1 result is . . . .
Response4: Subtask2 result is . . . .
Response5: Now putting it together
Response6: The final result of TaskA is . . . .

The parallel processing engine 108 and the nested loop engine 110 have been described above as two separate engines or application programs. However, it is understood that the parallel processing engine 108 and the nested loop engine 110 may be integrated together as part of a single engine or application program.

FIG. 11 illustrates an exemplary computing system 300 that may be server 102 or server used to implement an embodiment of the present technology. The computing system 300 of FIG. 11 includes one or more processors 310 and main memory 320. Main memory 320 stores, in part, instructions and data for execution by processor unit 310. Main memory 320 can store the executable code when the computing system 300 is in operation. The computing system 300 of FIG. 11 may further include a mass storage device 330, portable storage medium drive(s) 340, output devices 350, user input devices 360, a display system 370, and other peripheral devices 380.

The components shown in FIG. 11 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a floppy disk, compact disk or Digital video disc, to input and output data and code to and from the computing system 300 of FIG. 11. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 11 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 11 are those typically found in computing systems that may be suitable for use with embodiments of the present invention and are intended to represent a broad category of such computer components that are well known in the art. Thus, the computing system 300 of FIG. 11 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, one embodiment of the present technology relates to a system for personalizing a generative artificial intelligence (GAI) virtual assistant implemented by a LLM engine, the system comprising: one or more service provider servers configured to: collect information about an individual user; store the information about the individual user; receive a query directed to the GAI virtual assistant; and direct the GAI virtual assistant to personalize a response to the received query using the stored information about the individual.

In another example, the present technology relates to a system for personalizing a generative artificial intelligence (GAI) virtual assistant implemented by a LLM engine, the system comprising: one or more service provider servers, the one or more service provider servers comprising: a context information collection engine configured to collect information about an individual user; a context information datastore configured to store the information collected by the context information collection engine; and a query formation engine configured to receive a query directed to the GAI virtual assistant, and embed information in the query directing the GAI virtual assistant to personalize a response to the received query using the stored information about the individual.

In a further example, the present technology relates to a method of personalizing a response from a generative artificial intelligence (GAI) virtual assistant, comprising the steps of: (a) building a datastore of personal information and user preferences for individual users; (b) receiving a query to the GAI virtual assistant; and (c) directing the GAI virtual assistant to personalize the response to the query using the information in the datastore.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A system for processing prompts to a large language model (LLM), comprising:
a parallel processing engine configured to receive a prompt, divide the prompt into two or more token groups, and send first and second token groups of the two or more token groups for processing by the LLM in parallel where the first and second token groups have not start condition to be satisfied; and
a nested loop engine configured to perform nested processing of the two or more token groups, wherein the second token group is sent for processing by the LLM upon satisfaction of a condition during processing of the first token group by the LLM.

2. The system of claim 1, wherein the parallel processing engine and the nested loop engine are integrated together in a single application program.

3. The system of claim 1, wherein the nested loop engine is configured to process two or more of the two or more token groups recursively based on satisfaction of conditions within the two or more token groups.

4. The system of claim 1, wherein at least one of the two or more token groups has dynamic states that change as the two or more token groups are processed by the LLM.

5. The system of claim 1, wherein the prompt processed by the LLM comprises a plurality of system prompts and a user prompt.

6. The system of claim 5, wherein the two or more token groups comprise one token group for each system prompt.

7. The system of claim 5, wherein the two or more token groups comprise one token group for the whole user prompt.

8. The system of claim 5, wherein the user prompt is broken into two or more token groups.

9. The system of claim 5, wherein at least one system prompt and at least a portion of the user prompt share a single token group of the two or more token groups.

10. The system of claim 1, wherein a token group comprises a key pair having a condition and an action upon satisfaction of the condition.

11. The system of claim 10, wherein the action is performed upon satisfaction of the condition prior to completion of processing the token group.

12. The system of claim 1, wherein a token group of the two or more token groups is not processed based on its start condition not being satisfied.

13. A system for processing prompts to a large language model (LLM), comprising:
a memory for storing software code;
one or more processors configured to execute the software code to:
receive the prompt,
divide the prompt into two or more token groups,
send a first token group of the two or more token groups to the LLM for processing, and
send a second token group of the two or more token groups to the LLM for processing after the first token group and upon satisfaction of a condition in the second token group.

14. The system of claim 13, wherein the processor is further configured to send a third token group of the two or more token groups to the LLM for processing in parallel with the first token group.

15. The system of claim 13, wherein the nested loop engine is configured to process the first token group to completion, then process the second token group, then process the first token group again based on satisfaction of a condition in the second token group directing that the first token group be processed again.

16. The system of claim 13, wherein at least one of the first and second token groups have dynamic states that change as the two or more token groups are processed by the LLM.

17. The system of claim 13, wherein processing of the first token group terminates before completion of processing by the LLM based on an end condition contained in the second token group.

18. The system of claim 13, wherein a token group of the two or more token groups comprises a key pair having a condition and action upon satisfaction of the condition.

19. The system of claim 18, wherein the action is performed upon satisfaction of the condition prior to completion of processing the token group.

20. A method of processing prompts to a large language model, comprising the steps of:
a) receiving the prompt;
b) dividing the prompt into a plurality of token groups;
c) sending first and second token groups of the plurality of token groups to the LLM for processing where the first and second token groups have no start condition;
d) sending a third token group to the LLM for processing after the first token group and upon satisfaction of a start condition in the third token group.

21. The method of claim 20, further comprising the step of processing the first token group a second time based on satisfaction of a condition in the second token group directing that the first token group be processed again.

22. The method of claim 20, further comprising the step of terminating processing of the second token group before completion of processing by the LLM based on an end condition contained in the second token group.

23. The method of claim 20, further comprising performing an action defined in the first token group upon satisfaction of a condition defined in the first token group.

24. The method of claim 23, further comprising performing the action upon satisfaction of the condition prior to completion of processing the first token group.
